(19) United States
(12) Patent Application Publication
(10) Pub. No.: US 2020/0117191 A1
(43) Pub. Date: Apr. 16, 2020

(54) VEHICLE CONTROL SYSTEM, VEHICLE CONTROL METHOD, AND PROGRAM

(71) Applicant: HONDA MOTOR CO., LTD., Minato-ku, Tokyo (JP)

(72) Inventors: Osamu Ito, Wako-shi (JP); Hidetoshi Nakamura, Wako-shi (JP); Masakuni Murakami, Wako-shi (JP)

(21) Appl. No.: 16/499,883

(22) PCT Filed: Apr. 7, 2017
(86) PCT No.: PCT/JP2017/014520

§ 371 Date: Oct. 1, 2019

(51) Int. Cl. G05D 1/00

(52) U.S. Cl. CPC G05D 1/0061

(57) ABSTRACT

A vehicle control system includes a state detector configured to detect a state of an occupant in a vehicle, and an automated driving controller configured to execute automated driving that automatically controls at least one of acceleration/deceleration or steering of the vehicle. In a case of a first state in which a posture of the occupant is a non-steady posture different from a steady posture or in a case of a second state in which a predetermined safety device is not attached to a body of the occupant, the automated driving controller is configured to change a control state of the vehicle from a first control state to a second control state in a case in which the occupant is not in the first state or the second state, on the basis of a detection result of the state detector.

### TECHNICAL FIELD

The present invention relates to a vehicle control system, a vehicle control method, and a program.

### BACKGROUND ART

A driving posture adjustment device mounted on an automated driving vehicle and adjusting a posture of a driver has been disclosed (for example, Patent Document 1). In a state in which automated driving is being performed, in a case in which it is determined that a driver intends to change a posture, the driving posture adjustment device is configured to change a state of a seat on which the driver is seated so that the driver is able to stretch the entire body.

### CITATION LIST

### Patent Literature

### [Patent Document 1]

Japanese Unexamined Patent Application, First Publication No. 2016-196225

### SUMMARY OF INVENTION

### Technical Problem

However, in the above-described technology, it has not been considered to appropriately control a control state of a vehicle in accordance with a state of an occupant.

The present invention has been made in consideration of such circumstances, and an object of the present invention is to provide a vehicle control system, a vehicle control method, and a program capable of appropriately controlling a control state of a vehicle in accordance with a state of an occupant.

### Solution to Problem

According to an aspect, a vehicle control system includes a state detector configured to detect a state of an occupant in a vehicle, and an automated driving controller configured to execute automated driving that automatically controls at least one of acceleration/deceleration or steering of the vehicle. In a case of a first state in which the posture of the occupant is a non-steady posture different from a steady posture or in a case of a second state in which a predetermined safety device is not attached to a body of the occupant, the automated driving controller is configured to change a control state of the vehicle from a first control state to a second control state in a case in which the occupant is not in the first state or the second state, on the basis of a detection result of the state detector.

According to another aspect, in the vehicle control system, the second control state is a control state in which a behavior change of the vehicle is less likely to occur or a control state in which a margin degree of avoidance of the vehicle for an obstacle present around the vehicle is increased, in comparison with the first control state.

According to another aspect, in the vehicle control system, the automated driving controller is configured to perform adjustment of a degree to which the behavior change of the vehicle is less likely to occur or a degree to which the margin degree of the avoidance of the vehicle for the obstacle present around the vehicle is increased, on the basis of the degree to which the posture of the occupant deviates from the steady posture.

According to another aspect, in the vehicle control system, the first state is a state in which a proportion of a portion of the body of the occupant present outside a range of a reference region that is set in advance is equal to or greater than a predetermined level.

According to another aspect, in the vehicle control system, the automated driving controller is configured to perform control so that the behavior change of the vehicle is less likely to occur or the margin degree of the avoidance of the vehicle for the obstacle present around the vehicle is increased in the second control state, as the number of predetermined parts of the body of the occupant present outside the range of the reference region that is set in advance is increased, or as a region of the body of the occupant present outside the range of the reference region that is set in advance is increased.

According to another aspect, in the vehicle control system, the second control state is a control state for reducing a vehicle speed of the vehicle.

According to another aspect, in the vehicle control system, the second control state in a state in which the vehicle follows a preceding vehicle is a control state in which a vehicle to be followed is changed to a vehicle having a slower speed than the vehicle to be followed.

According to another aspect, in the vehicle control system, the second control state is a control state in which an inter-vehicle distance with the preceding vehicle is increased.

According to another aspect, in the vehicle control system, the second control state is a control state in which a lane change of the vehicle is prohibited.

According to another aspect, the vehicle control system further includes a surrounding situation detector configured to detect a surrounding situation of the vehicle, and the automated driving controller is configured to decelerate the vehicle as the second control state and stop the vehicle in a case in which it is determined that a congestion degree around the vehicle is high on the basis of a detection result of the surrounding situation detector.

According to another aspect, in the vehicle control system, a fact that the congestion degree is high is a fact that it is detected that the number of surrounding vehicles is greater than or equal to a predetermined number by the surrounding situation detector.

According to another aspect, in the vehicle control system, in a case in which the occupant is in the first state or the second state and the occupant is performing a predetermined operation, the automated driving controller is configured to perform the control so that the behavior change of the vehicle is less likely to occur or the margin degree of the avoidance of the vehicle for the obstacle present around the vehicle is increased in the second control state, in comparison with a case in which the occupant is in the first state or the second state and the occupant is not performing the predetermined operation.

According to another aspect, in the vehicle control system, in a case in which the occupant is in the first state or the occupant is in the second state and the occupant stands up, the automated driving controller is configured to perform the control so that the behavior change of the vehicle is less likely to occur or the margin degree of the avoidance of the vehicle for the obstacle present around the vehicle is increased in the second control state, in comparison with a case in which the occupant is in the first state or the occupant is in the second state and the occupant does not stand up.

According to another aspect, in the vehicle control system, in a case in which the occupant is in the first state or the second state and the occupant stands up, the automated driving controller is configured to decelerate the vehicle as the second control state while the state continues.

According to another aspect, in the vehicle control system, in a case in which a disposition of a seat in the vehicle is different from a reference disposition that is set in advance and the occupant is in the first state or the occupant is in the second state, the automated driving controller is configured to perform the control so that the behavior change of the vehicle is less likely to occur or the margin degree of the avoidance of the vehicle for the obstacle present around the vehicle is increased in the second control state, in comparison with a case in which the disposition of the seat in the vehicle is the reference disposition that is set in advance and the occupant is in the first state or the occupant is in the second state.

According to another aspect, a vehicle control method causes an in-vehicle computer to detect a state of an occupant in a vehicle, execute automated driving that automatically controls at least one of acceleration/deceleration or steering of the vehicle, and change a control state of the vehicle from a first control state to a second control state in a case in which the occupant is not in the first state or the second state, in a case of a first state in which a posture of the occupant is a non-steady posture different from a steady posture or in a case of a second state in which a predetermined safety device is not attached to a body of the occupant, on the basis of a result of the detection result.

According to another aspect, a non-transitory computer-readable storage medium that stores a computer program to be executed by a computer to perform at least: detect a state of an occupant in a vehicle, execute automated driving that automatically controls at least one of acceleration/deceleration or steering of the vehicle, and change a control state of the vehicle from a first control state to a second control state in a case in which the occupant is not in the first state or the second state, in a case of a first state in which a posture of the occupant is a non-steady posture different from a steady posture or in a case of a second state in which a predetermined safety device is not attached to a body of the occupant, on the basis of a result of the detection result.

### Advantageous Effects of Invention

According to an aspect, it is possible to appropriately control the control state of the vehicle in accordance with the state of the occupant.

According to another aspect, in a case in which the automated driving controller determines that the congestion degree is high, it is possible to control the subject vehicle more appropriately by decelerating the vehicle and stopping the vehicle.

### BRIEF DESCRIPTION OF DRAWINGS

FIG. 1 is a constitution diagram of a vehicle system including an automated driving controller.

FIG. 2 is a diagram showing an aspect in which a subject vehicle position recognizer recognizes a relative position and a posture of the subject vehicle with respect to a traveling lane.

FIG. 3 is a diagram showing an aspect in which a target trajectory is generated on the basis of a recommended lane.

FIG. 4 is a diagram showing an example of a state of a seat of the subject vehicle.

FIG. 5 is a diagram showing content of seat state information.

FIG. 6 is a diagram showing content of information of basic posture information.

FIG. 7 is a diagram showing an example of a reference region.

FIG. 8 is a diagram showing an example of content of control state adjustment information.

FIG. 9 is a diagram showing another example of the content of the control state adjustment information.

FIG. 10 is a flowchart showing a flow of a process executed by the automated driving controller.

FIG. 11 is a diagram showing an example of basic posture information including a reference region set for each state of the seat.

FIG. 12 is a diagram showing a functional constitution of a vehicle system of a second embodiment.

FIG. 13 is a flowchart showing a flow of a process executed by the automated driving controller of the second embodiment.

FIG. 14 is a diagram showing an example of content of control state adjustment information.

FIG. 15 is a diagram showing an appearance of an air bag jacket.

FIG. 16 is a diagram showing an example of content of control state adjustment information.

FIG. 17 is a diagram showing the disposition of the seats.

### DESCRIPTION OF EMBODIMENTS

Hereinafter, embodiments of a vehicle control system, a vehicle control method, and a program of the present invention will be described with reference to the drawings. Hereinafter, the embodiments will be described using XYZ coordinates as necessary. A plus X direction is a progress direction of a vehicle, and a plus Y direction is substantially perpendicular to the progress direction and is a left direction with respect to the progress direction of the vehicle. A plus Z direction is a direction that intersects the XY directions, and is a direction opposite to a substantially vertical direction.

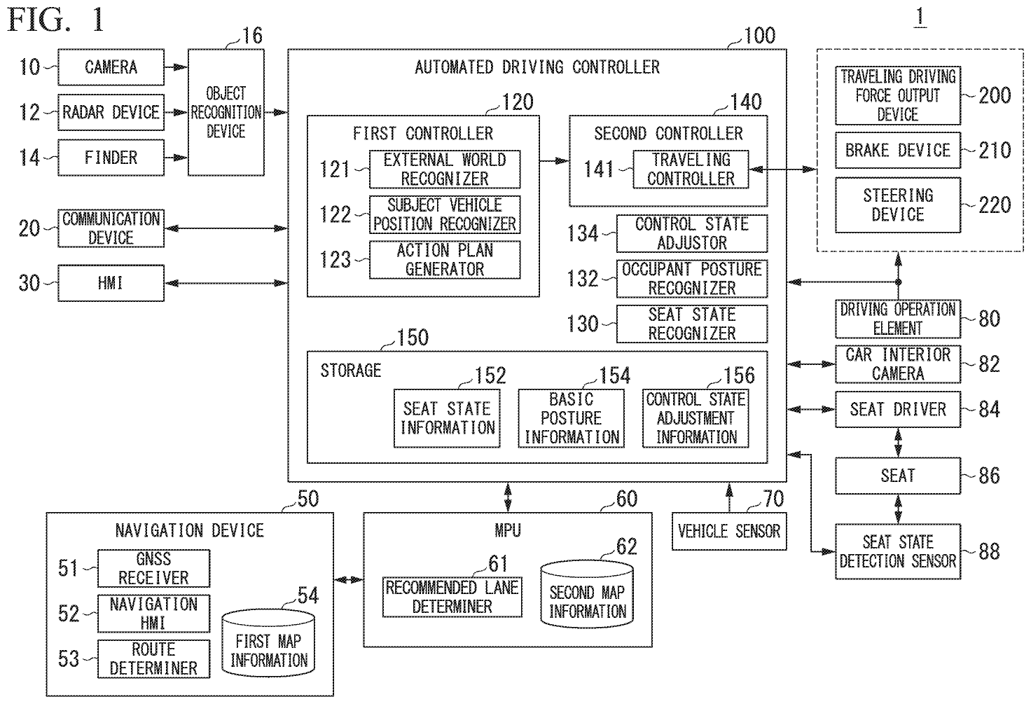

### First Embodiment

[Overall constitution] FIG. 1 is a constitution diagram of a vehicle system 1 including an automated driving controller 100. A vehicle in which the vehicle system 1 is mounted is, for example, a vehicle such as a two-wheeled vehicle, a three-wheeled vehicle, or a four-wheeled vehicle, and a driving source of the vehicle is an internal combustion engine such as a diesel engine or a gasoline engine, an electric motor, or a combination thereof. The electric motor operates using electric power generated by a generator connected to the internal combustion engine or electric power discharged by a secondary battery or a fuel cell.

For example, the vehicle system 1 includes a camera 10, a radar device 12, a finder 14, an object recognition device 16, a communication device 20, a human machine interface (HMI) 30, a navigation device 50, a micro-processing unit (MPU) 60, a vehicle sensor 70, a driving operation element 80, a vehicle interior camera 82, a seat driver 84, a seat 86, a seat state detection sensor 88, the automated driving controller 100, a traveling driving force output device 200, a brake device 210, and a steering device 220. Such devices and instruments are connected to each other by a multiple communication line such as a controller area network (CAN) communication line, a serial communication line, a wireless communication network, or the like. Note that, the constitution shown in FIG. 1 is merely an example, and a part of the constitution may be omitted or another constitution may be further added.

For example, the camera 10 is a digital camera using a solid imaging element such as a charge coupled device (CCD) or a complementary metal oxide semiconductor (CMOS). One or a plurality of cameras 10 are attached to arbitrary places on the vehicle (hereinafter, referred to as a subject vehicle M) in which the vehicle system 1 is mounted. In a case of forward imaging, the camera 10 is attached to an upper portion of a front windshield, a rear surface of a rearview mirror, or the like. For example, the camera 10 periodically repeats imaging of the surroundings of the subject vehicle M. The camera 10 may be a stereo camera.

The radar device 12 radiates radio waves such as millimeter waves or the like to the surroundings of the subject vehicle M and detects at least the position (distance and direction) of an object by detecting radio waves (reflected waves) reflected by the object. One or a plurality of radar devices 12 are attached to arbitrary places on the subject vehicle M. The radar device 12 may detect the position and the speed of the object by a frequency modulated continuous wave (FM-CW) method.

The finder 14 is light detection and ranging or laser imaging detection and ranging (LIDAR) which measures scattered light with respect to the irradiation light and detects the distance to the object. One or a plurality of finders 14 are attached to arbitrary places on the subject vehicle M.

The object recognition device 16 performs a sensor fusion process on a detection result by a part or all of the camera 10, the radar device 12, and the finder 14 to recognize a position, a type, a speed, and the like of the object. The object recognition device 16 outputs a recognition result to the automated driving controller 100.

For example, the communication device 20 communicates with another vehicle that is present around the subject vehicle M using a cellular network, a Wi-Fi network, Bluetooth (registered trademark), dedicated short range communication (DSRC), or the like, or communicates with various server devices through a wireless base station.

The HMI 30 presents various types of information to an occupant of the subject vehicle M and receives an input operation by the occupant. The HMI 30 includes various display devices, speakers, buzzers, touch panels, switches, keys, and the like.

For example, the navigation device 50 includes a global navigation satellite system (GNSS) receiver 51, a navigation HMI 52, and a route determiner 53, and holds first map information 54 in a storage device such as a hard disk drive (HDD) or a flash memory. The GNSS receiver specifies the position of the subject vehicle M on the basis of a signal received from a GNSS satellite. The position of the subject vehicle M may be specified or supplemented by an inertial navigation system (INS) using an output of the vehicle sensor 70. The navigation HMI 52 includes a display device, a speaker, a touch panel, a key, and the like. A part or all of the navigation HMI 52 may be shared with the HMI 30 described above. For example, the route determiner 53 determines a route from the position of the subject vehicle M specified by the GNSS receiver 51 (or an input arbitrary position) to a destination input by the occupant using the navigation HMI 52 by referring to the first map information 54. For example, the first map information 54 is information in which a road shape is expressed by a link indicating a road and nodes connected by the link. The first map information 54 may include a curvature of the road, point of interest (POI) information, or the like. The route determined by the route determiner 53 is output to the MPU 60. In addition, the navigation device 50 may perform route guidance using the navigation HMI 52 on the basis of the route determined by the route determiner 53. Note that, for example, the navigation device 50 may be implemented by a function of a terminal device such as a smartphone or a tablet terminal possessed by the user. In addition, the navigation device 50 may transmit a current position and a destination to a navigation server through the communication device 20 and acquire the route returned from the navigation server.

For example, the MPU 60 functions as a recommended lane determiner 61 and holds second map information 62 in the storage device such as an HDD or a flash memory. The recommended lane determiner 61 divides the route provided from the navigation device 50 into a plurality of blocks (for example, divides the route into intervals of 100 [m] in a vehicle progress direction), and determines a target lane for each block by referring to the second map information 62. The recommended lane determiner 61 determines the number of a lane from the left that the vehicle travels in. In a case where a branching position, a merging position, or the like is present on the route, the recommended lane determiner 61 determines the recommended lane so that the subject vehicle M is able to travel on a reasonable travel route for progressing to a branch destination.

The second map information 62 is map information with accuracy higher than that of the first map information 54. For example, the second map information 62 may include information on the center of a lane, information on a boundary of a lane, or the like. In addition, the second map information 62 may include road information, traffic regulation information, address information (an address and a postal code), facility information, telephone number information, and the like. The road information includes information indicating a type of a road such as an expressway, a toll road, a national road, and a prefectural road, information on the number of lanes of the road, widths of each lane, a slope of a road, a position of a road (three-dimensional coordinates including longitude, latitude, height), a curvature of a curve of a lane, positions of merging and branching points of lanes, a sign provided on a road, and the like. The second map information 62 may be updated at any time by accessing another device using the communication device 20.

In addition, the second map information 62 stores information indicating a gate structure such as an entrance toll gate or an exit toll gate. The information indicating the gate structure is, for example, the number of gates provided at the toll gate, information indicating a position of the gate, and information indicating a type of the gate (information such as an ETC dedicated gate or a general gate).

The vehicle sensor 70 includes a vehicle speed sensor that detects a speed of the subject vehicle M, an acceleration sensor that detects acceleration, a yaw rate sensor that detects an angular velocity around a vertical axis, an orientation sensor that detects a direction of the subject vehicle M, and the like.

The driving operation element 80 includes, for example, an acceleration pedal, a brake pedal, a shift lever, a steering wheel, and other operation elements. A sensor that detects an operation amount or presence or absence of an operation is attached to the driving operation element 80, and a detection result of the sensor is output to at least one or both of the automated driving controller 100 or the traveling driving force output device 200, the brake device 210, and the steering device 220.

The vehicle interior camera 82 images scenery inside the vehicle. A captured image of the vehicle interior camera 82 is output to the automated driving controller 100A. Note that the vehicle interior camera 82 is not limited to one, and a plurality of vehicle interior cameras 82 may be provided in the vehicle.

Details of the seat driver 84, the seat 86, and the seat state detection sensor 88 will be described later.

For example, the automated driving controller 100 includes a first controller 120, a seat state recognizer 130, an occupant posture recognizer 132, a control state adjustor 134, a second controller 140, and a storage 150. Some or all of each of the first controller 120, the seat state recognizer 130, the occupant posture recognizer 132, the control state adjustor 134, and the second controller 140 are implemented by a processor such as a central processing unit (CPU) executing a program (software). In addition, some or all of each functional unit may be implemented by hardware such as a large scale integration (LSI), an application specific integrated circuit (ASIC), or a field-programmable gate array (FPGA), or may be implemented by cooperation of software and hardware. The storage 150 is realized by an HDD or a flash memory. The storage 150 stores seat state information 152, basic posture information 154, and control state adjustment information 156, which will be described later.

The first controller 120 includes, for example, an external world recognizer 121, a subject vehicle position recognizer 122, and an action plan generator 123.

The external world recognizer 121 recognizes states such as the position, the speed and the acceleration of the surrounding vehicle on the basis of information input from the camera 10, the radar device 12, and the finder 14 through the object recognition device 16. The position of the surrounding vehicle may be represented by the representative point such as the center of gravity or a corner of the surrounding vehicle, or may be represented by a region expressed by a contour of the surrounding vehicle. The “state” of the surrounding vehicle may include acceleration or a jerk of the surrounding vehicle, or an “action state” (for example, whether or not the surrounding vehicle is changing lanes or trying to change lanes). In addition, the external world recognizer 121 may also recognize positions of other objects such as a guardrail, a utility pole, a parked vehicle, or a pedestrian, in addition to the surrounding vehicle.

For example, the subject vehicle position recognizer 122 recognizes a lane (traveling lane) on which the subject vehicle M is traveling, and a relative position and a posture of the subject vehicle M with respect to the traveling lane. For example, the subject vehicle position recognizer 122 recognizes the traveling lane by comparing a pattern of a road lane marking (for example, an arrangement of a solid line and a broken line) obtained from the second map information 62 with a pattern of a road lane marking around the subject vehicle M recognized from the image captured by the camera 10. In this recognition, the position of the subject vehicle M acquired from the navigation device 50 or a process result by an INS may be added.

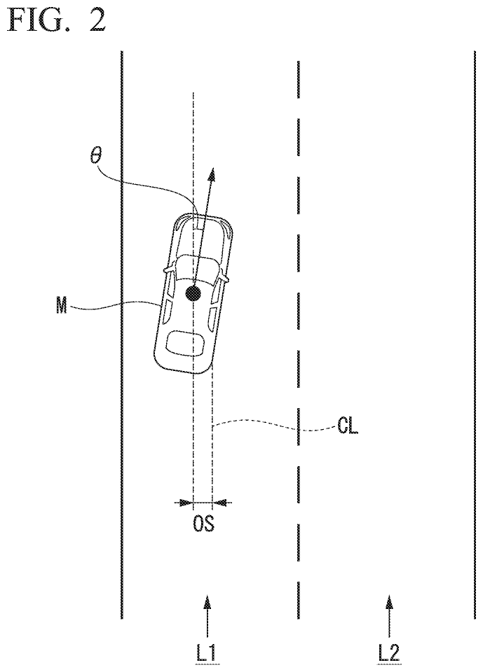

In addition, for example, the subject vehicle position recognizer 122 recognizes the position and a posture of the subject vehicle M with respect to the traveling lane. FIG. 2 is a diagram showing an aspect in which the subject vehicle position recognizer 122 recognizes the relative position and the posture of the subject vehicle M with respect to the traveling lane. For example, the subject vehicle position recognizer 122 recognizes a deviation OS of a reference point (for example, the center of gravity) of the subject vehicle M from a traveling lane center CL an angle θ formed by a line connecting the traveling lane center of a progress direction of the subject vehicle M as the relative position and the posture CL of the subject vehicle M with respect to the traveling lane L1. Note that, instead of this, the subject vehicle position recognizer 122 may recognize a position or the like of the reference point of the subject vehicle M with respect to one of side end portions of the subject lane L1 as the relative position of the subject vehicle M with respect to the traveling lane. The relative position of the subject vehicle M recognized by the subject vehicle position recognizer 122 is provided to the recommended lane determiner 61 and the action plan generator 123.

The action plan generator 123 generates a target trajectory on which the subject vehicle M travels in the future, as described below, on the basis of a process result of the control state adjustor 134. The action plan generator 123 determines the events to be sequentially executed in the automated driving so that the subject vehicle M travels on the recommended lane determined by the recommended lane determiner 61 and further copes with the surrounding situation of the subject vehicle M. The events include, for example, a constant-speed traveling event in which the subject vehicle M travels on the same traveling lane at a constant speed, a follow-up traveling event in which the subject vehicle M follows the preceding vehicle, a lane change event, a merge event, a branch event, an emergency stop event, and a handover event for switching driving to the manual driving by ending the automated driving, and a toll gate event (described later) executed when passing through the toll gate. In addition, during the execution of these events, an action for avoidance may be planned on the basis of the surrounding situation (the presence of the surrounding vehicle or the pedestrian, lane constriction due to road construction, and the like) of the subject vehicle M.

The action plan generator 123 generates a target trajectory in which the subject vehicle M travels in the future. The target trajectory includes, for example, a speed element. For example, the target trajectory is generated by setting a plurality of future reference times for each predetermined sampling time (for example, about 0.X [sec]), and is generated as a set of target points (trajectory points) to be reached at such reference times. Therefore, in a case in which a distance between the trajectory points is wide, it indicates that a vehicle travels a section between the trajectory points at high speed.

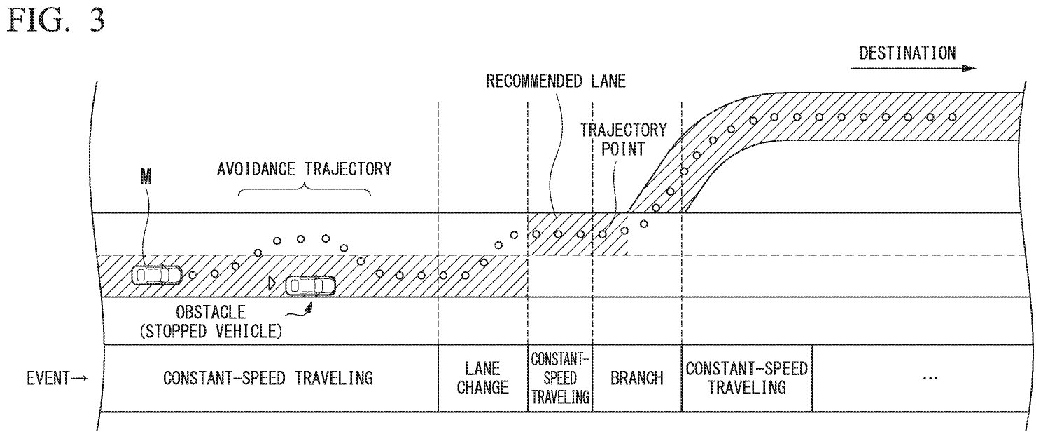

FIG. 3 is a diagram showing an aspect in which the target trajectory is generated on the basis of the recommended lane. As shown in the drawing, the recommended lane is set so that traveling along the route to the destination is convenient. The action plan generator 123 activates a lane change event, a branch event, a merge event, or the like when approaching a predetermined distance before a switching point of the recommended lane (which may be determined according to a kind of event). In a case where it is necessary to avoid an obstacle during the execution of each event, an avoidance trajectory is generated as shown in the drawing.

The action plan generator 123 generates, for example, a plurality of candidates of the target trajectory, and selects an optimal target trajectory at that time on the basis of a viewpoint of safety and efficiency.

Details of the processes of the seat state recognizer 130, the occupant posture recognizer 132, and the control state adjustor 134 will be described later.

The second controller 140 includes a traveling controller 141. The traveling controller 141 controls the traveling driving force output device 200, the brake device 210, and the steering device 220 so that the subject vehicle M passes through the target trajectory generated by the action plan generator 123 at a scheduled time.

The traveling driving force output device 200 outputs, to driving wheels, traveling driving force (torque) for enabling the vehicle to travel. For example, the traveling driving force output device 200 includes a combination of an internal combustion engine, an electric motor, a transmission, and the like, and an ECU that controls the internal combustion engine, the electric motor, the transmission, and the like. The ECU controls the above-described constitutions according to the information input from the traveling controller 141 or the information input from the driving operation element 80.

For example, the brake device 210 includes a brake caliper, a cylinder that transfers oil pressure to the brake caliper, an electric motor that generates the oil pressure in the cylinder, and a brake ECU. The brake ECU controls the electric motor according to the information input from the traveling controller 141 or the information input from the driving operation element 80, so that a brake torque according to a control operation is output to each wheel. The brake device 210 may include a mechanism for transferring the oil pressure generated by an operation of a brake pedal included in the driving operation element 80 to the cylinder through a master cylinder as a backup. Note that, the brake device 210 is not limited to the constitution described above, and may be an electronic control method oil pressure brake device that controls an actuator according to the information input from the traveling controller 141 to transfer the oil pressure of the master cylinder to the cylinder.

For example, the steering device 220 includes a steering ECU and an electric motor. For example, the electric motor changes a direction of steerable wheels by applying a force to a rack and pinion mechanism. The steering ECU changes the direction of the steerable wheels by driving the electric motor according to the information input from the traveling controller 141 or the information input from the driving operation element 80.

[Process of Recognizing State of Seat]

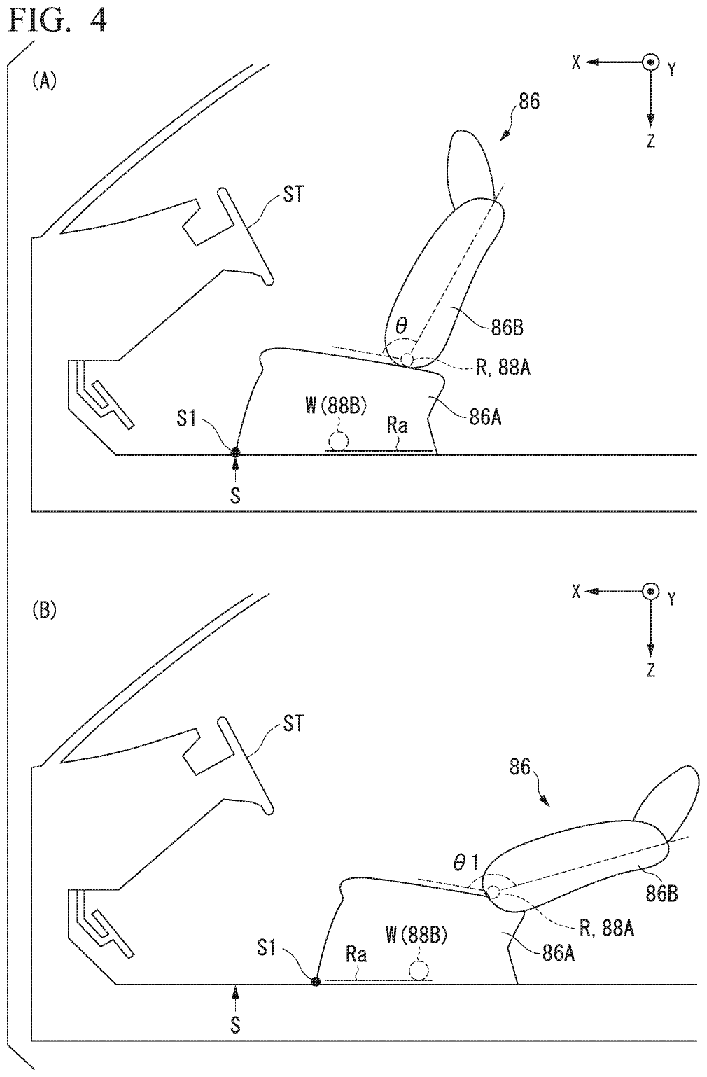

FIG. 4 is a diagram showing an example of the state of the seat 86 of the subject vehicle M. The seat 86 is, for example, a seat on a driver's seat side provided with a steering wheel ST. The seat 86 includes a seat portion (seat cushion) 86A and a backrest portion (seat back) 86B. The seat portion 86A is movable with respect to a floor surface in a vehicle interior. The backrest portion 86B rotates about a rotation axis R along a Y-axis direction. (B) of FIG. 4 shows a state in which the backrest portion 86B is inclined at a predetermined angle and the seat 86 is moved a predetermined distance in a negative X direction with respect to (A) of FIG. 4. Note that the seat 86 is controlled, for example, by performing a predetermined operation on the HMI 30.

The seat driver 84 includes a plurality of drivers (motors) that control the state of the seat 86 in the vehicle interior. The seat driver 84 transfers a generated driving force to the seat 86, for example, through a power transfer mechanism. The state of the seat 86 is, for example, an inclination degree of the backrest portion 86B of the seat 86 (for example, 0 of (A) of FIGS. 4 and 01 of (B) of FIG. 4), or a position of the seat portion 86A of the seat 86. The seat driver 84 gives power to a reclining mechanism that inclines the backrest portion 86B of the seat 86 to control the inclination degree of the backrest portion 86B.

The position of the seat portion 86A is a position Si of the seat portion 86A in the X direction with respect to a reference position S of the floor surface in the vehicle interior. A wheel W rotatable by the power output by the seat driver 84 is provided on a floor surface side of the seat portion 86A of the seat 86. In addition, a rail mechanism Ra for guiding a wheel W in the X direction is provided on the floor surface of the vehicle interior. The seat driver 84 rotates the wheel W of the seat portion 86A of the seat 86 to move the seat 86 in a direction along the rail mechanism Ra. Note that the seat 86 and the rail mechanism Ra may be provided so as to be movable in the Y direction as well as the X direction.

The seat state detection sensor 88 includes seat state detection sensors 88A and 88B. The seat state detection sensor 88A detects a rotation angle of a rotation axis R of the backrest portion 86B, and outputs a detection result to the seat state recognizer 130. The seat state detection sensor 88B detects a rotation angle of the seat driver 84 (motor) that rotates the wheel W, and outputs a detection result to the seat state recognizer 130. Note that a vehicle interior camera 90 images the driver, for example, from a lateral direction (minus Y direction).

The seat state recognizer 130 recognizes the inclination degree of the backrest portion 86B on the basis of the detection result of the seat state detection sensor 88A. The seat state recognizer 130 recognizes the position of the seat 86 with respect to the reference position S on the basis of the detection result of the seat state detection sensor 88B. Note that the storage 150 stores conversion information for converting the detection result of the seat state detection sensor 88A into the inclination degree of the backrest portion 86B and conversion information for converting the detection result of the seat state detection sensor 88B into the position of the seat 86. The seat state recognizer 130 recognizes the detection result of the seat state detection sensor 88 as the inclination degree of the backrest portion 86B or the position of the seat 86 with respect to the reference position S, with reference to the conversion information described above.

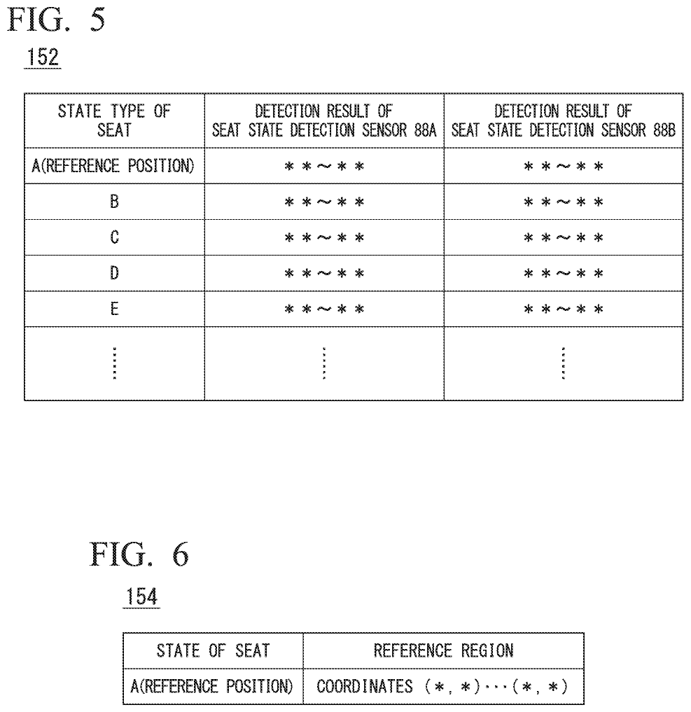

In addition, the seat state recognizer 130 determines a type of the state of the seat 86 on the basis of the detection result of the seat state detection sensor 88 with reference to the seat state information 152. FIG. 5 is a diagram showing content of the seat state information 152. The seat state information 152 is information in which the detection result of the seat state detection sensor 88A and the detection result of the seat state detection sensor 88A are associated with the type of the state of the seat 86. For example, in a state of the seat 86 shown in (A) of FIG. 4, in a case in which the seat state recognizer 130 acquires the detection result of the seat state detection sensor 88, the seat state recognizer 130 recognizes that the state of the seat 86 is a type A. In a state of the seat 86 shown in (B) of FIG. 4, in a case in which the seat state recognizer 130 acquires the detection result of the seat state detection sensor 88, the seat state recognizer 130 recognizes that the state of the seat 86 is a type different from the type A. Note that the type A is a reference state of the seat 86.

[Process of Recognizing Posture of Occupant]

The occupant posture recognizer 132 refers to the basic posture information 154 to determine whether or not the occupant is present in the reference region on the basis of the image captured by the vehicle interior camera 90. The reference region is, for example, a reference region in which a predetermined surplus region is added to the reference position of the occupant set with respect to the reference state of the seat 86. FIG. 6 is a diagram showing content of information of the basic posture information 154. The basic posture information 154 stores information (coordinates) indicating a reference region on an image plane captured by the vehicle interior camera 90.

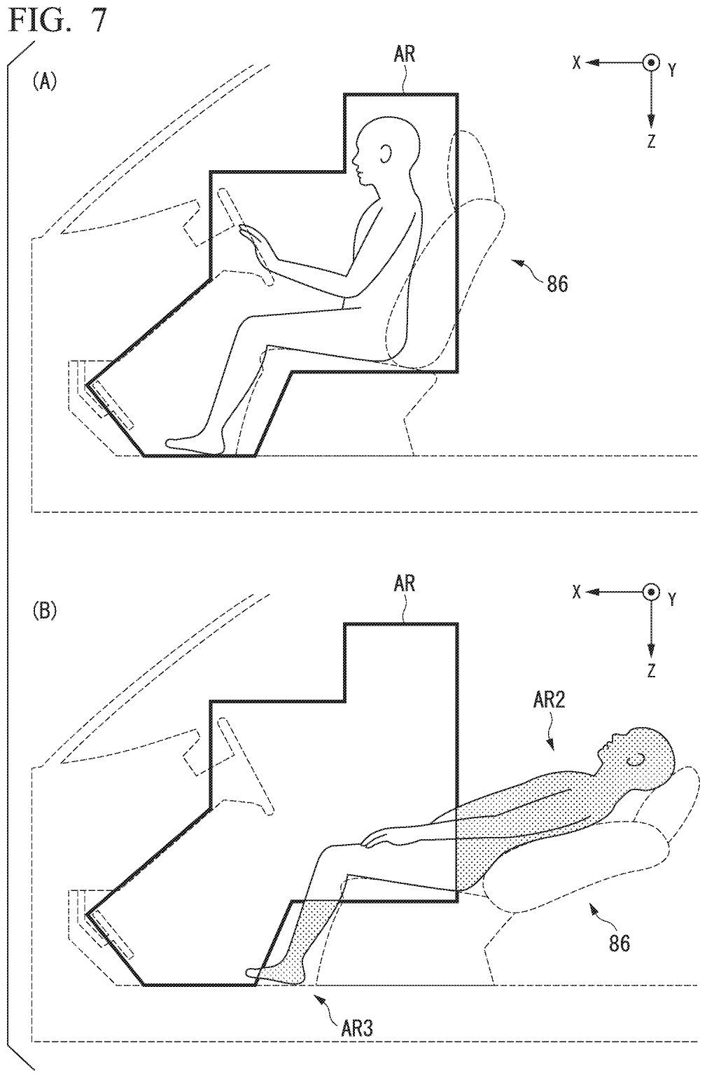

FIG. 7 is a diagram showing an example of the reference region. As shown in (A) of FIG. 7, the reference position of the occupant is the position of body of the occupant associated with a normal posture of the occupant when the occupant is seated on the seat 86 in a case in which the seat 86 is in the reference state. The reference region is a region including the body of the occupant. A state in which the occupant deviates from the reference region is an example of a “first state in which the occupant is in a non-steady posture different from a steady posture”.

The occupant posture recognizer 132 analyzes the image captured by the vehicle interior camera 90 to recognize the position of the body of the occupant on the image. The occupant posture recognizer 132 recognizes the body of the occupant present outside a range of the reference region AR stored in the basic posture information 154 and the body of the occupant present in a range of the reference region. In addition, the occupant posture recognizer 132 derives a deviation index indicating a degree of the region of the body of the occupant deviating from the reference region AR with respect to the region (on the image) of the body of the occupant. For example, as shown in (B) of FIG. 7, the occupant posture recognizer 132 derives the deviation index indicating a region AR1 (AR2 and AR3 indicated by hatching) of the body of the occupant deviating from the reference region AR. For example, the deviation index tends to increase as the region of the body of the occupant deviating from the reference region AR in the image captured by the vehicle interior camera 90 increases. For example, a state in which a proportion of a portion of the body of the occupant outside the range of the reference region that is set in advance is equal to or greater than a predetermined level is an example of the “first state”.

In addition, the deviation indicator may be derived on the basis of the number of deviations of the body of the occupant from the reference region AR. The number of deviations is, for example, the number of parts of the body deviating from the reference region AR. The occupant posture recognizer 132 refers to, for example, information indicating a shape of each part of the occupant (human) stored in the storage 150 in advance to specify which part the part of the occupant in the image is. In addition, the occupant posture recognizer 132 determines whether or not the part deviates from the reference region AR for each of the specified parts. For example, in a case in which a foot, a head, the body, and an arm deviate from the reference region AR, the occupant posture recognizer 132 determines that the number of deviations is “4”, and derives the index according to the determined number. The part may be classified into, for example, a head, a body, an arm, a leg, a buttock, and the like, or may be classified in more detail. In addition, deviating may mean that all of the part deviate, or that a predetermined percentage of the part may deviate. For example, the deviation index tends to increase as the number of parts of the body of the occupant deviating from the reference region AR increases. Note that the deviation index may be determined for each part deviating from the reference region AR. For example, an importance may be set to the deviating part, and the deviation index may be derived higher in a case in which the part of which the importance is high deviates from the reference region AR.

Note that in the example described above, although the example in which the deviation index is derived on the basis of the image captured from the minus Y direction has been described, the present invention is not limited thereto. The occupant posture recognizer 132 may derive the deviation index on the basis of, for example, an image captured in the plus (or minus) X direction, the minus Y direction, or the plus Z direction. In this case, for example, the basic posture information 154 stores a reference region associated with a captured image plane captured from each direction. The occupant posture recognizer 132 derives the deviation index indicating the degree of the region of the body of the occupant deviating from the reference region AR, for each image captured from each direction. The occupant posture recognizer 132 statistically processes (for example, averages) the derived deviation indices, and derives the deviation index to be used in a process described later.

[Process of Adjusting Control State]

The control state adjustor 134 refers to the control state adjustment information 156, derives an index indicating a degree to which a movement state is reduced, and determines permission of lane change, branching, and merging or prohibition of the lane change, the branching, and the merging on the basis of a recognition result of the seat state recognizer 130 and a recognition result of the occupant posture recognition section 132. Reducing the movement state includes, for example, reducing the acceleration or jerk of the vehicle, reducing the speed of the vehicle, reducing a change amount of the steering angle of the vehicle, and the like. A state in which the movement state is reduced or a state in which the lane change, the branching, and the merging are prohibited are examples of a “second control state”. In addition, the second control state may be, for example, a state in which an inter-vehicle distance with a preceding vehicle is increased or a state in which a vehicle to be followed is changed to a vehicle having a slower speed than the vehicle to be followed, in comparison with a first control state in a case in which the posture of the occupant is not in the first state (or the second state described later).

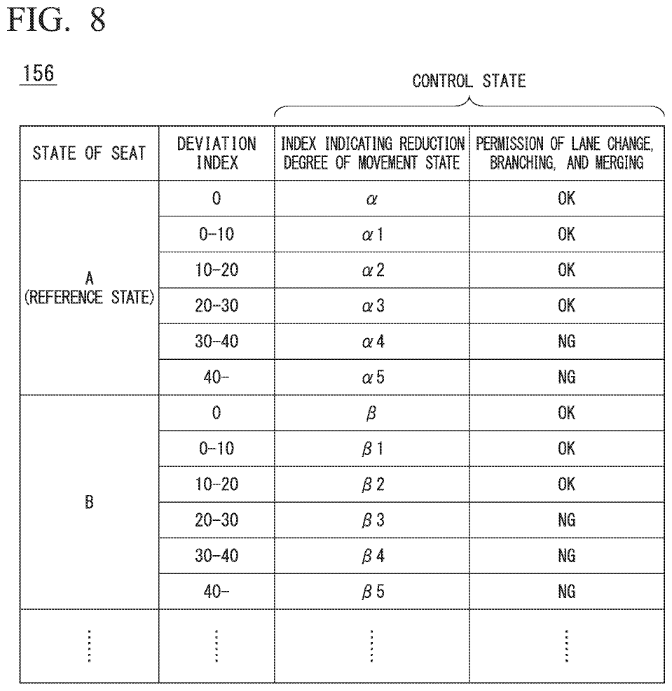

FIG. 8 is a diagram showing an example of content of the control state adjustment information 156. In the control state adjustment information 156, an index indicating the degree to which the movement state is reduced and the information indicating whether to permit the lane change, the branching, and the merging or whether to prohibit the lane change, the branching, and the merging are associated with the state of the seat 86 and the deviation index. For example, the index indicating the reduction degree of the movement state increases as the deviation index increases. In addition, the index indicating the reduction degree of the movement state increases in a case in which the state of the seat 86 is different from the reference state in comparison with a case of the reference state. Note that, in the control state adjustment information 156, the index indicating the degree to which the movement state is reduced, and the information for permitting the lane change, the branching, or the merging or prohibiting the lane change, the branching, or the merging may be associated with one of the state of the seat 86 or the deviation index. In addition, in the control state adjustment information 156, the index indicating the degree to which the movement state is reduced may be omitted, and the information for permitting the lane change, the branching, or the merging or prohibiting the merging may be associated. In addition, in the control state adjustment information 156, information for permitting the branching or the merging or prohibiting the merging may be omitted.

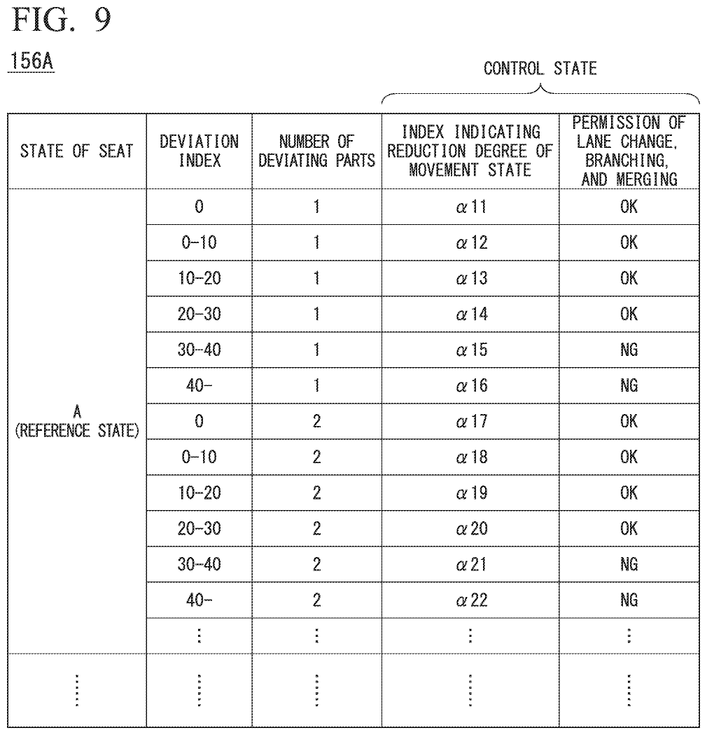

FIG. 9 is a diagram showing another example of the content of the control state adjustment information 156A. In the control state adjustment information 156, the index indicating the degree to which the movement state is reduced and the information indicating whether to permit the lane change, the branching, and the merging or whether to prohibit the lane change, the branching, and the merging are associated with the state of the seat 86, the deviation index indicating the degree of the region of the body of the occupant deviating from the reference area AR, and the number of deviating parts. For example, the index indicating the reduction degree of the movement state increases as the deviation index or the number of deviating parts increases. Note that an item of the deviation index may be omitted in the control state adjustment information 156A.

[Flowchart]

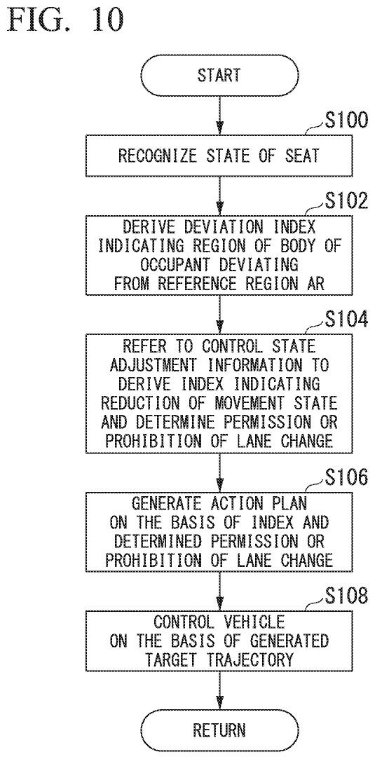

FIG. 10 is a flowchart showing a flow of a process executed by the automated driving controller 100. First, the seat state recognizer 130 refers to the seat state information 152 to recognize the state (type) of the seat 86 on the basis of the detection result of the seat state detection sensor 88A and the detection result of the seat state detection sensor 88B (step S100). Next, the occupant posture recognizer 132 refers to the basic posture information 154 to derive the deviation index indicating the degree of the region of the body of the occupant deviating from the reference region AR on the basis of the image captured by the vehicle interior camera 90 (step S102).

Next, the control state adjustor 134 refers to the control state adjustment information 156 to derive the index indicating the degree to which the movement state is reduced and determine the permission of the lane change or the prohibition of the lane change, on the basis of the recognition result of the seat state recognizer 130 and the recognition result of the occupant posture recognizer 132 (step S104).

Next, the action plan generator 123 generates the action plan on the basis of the index derived in step S104 and the permission of the lane change or the prohibition of the lane change determined in step S104 (step S106). For example, in a case in which it is determined by the control state adjustor 134 that the lane change is prohibited, the action plan generator 123 generates an action plan in which the lane change is not performed.

In addition, the action plan generator 123 generates the target trajectory along which the subject vehicle M travels in the future on the basis of the index derived by the control state adjustor 134. Specifically, the action plan generator 123 generates the target trajectory according to the index indicating the reduction degree of the movement state except in a case in which the seat 86 is in the reference state and the body of the occupant does not deviate from the reference region AR. This target trajectory is a target trajectory along which the subject vehicle M behaves so that the movement state is reduced in comparison with a case in which the seat 86 is in the reference state and the body of the occupant does not deviate from the reference region AR. The target trajectory along which the subject vehicle M behaves so that the movement state is reduced is, for example, a target trajectory for reducing the vehicle speed in comparison with a case in which the seat 86 is in the reference state and the body of the occupant does not deviate from the reference region AR. In addition, the automated driving controller 100 controls the subject vehicle M on the basis of the target trajectory generated by the action plan generator 123 (step S108). Therefore, a process of one routine of the present flowchart is ended.

In addition, in a case in which the body of the occupant deviates from the reference region AR, the action plan generator 123 may generate a target trajectory that increases the inter-vehicle distance with the preceding vehicle. In addition, the action plan generator 123 may generate a target trajectory that changes the vehicle to be followed to a vehicle slower than the vehicle to be followed in a state in which the subject vehicle M follows the preceding vehicle. The generation of these target trajectories is an example of the “second control state”. Note that the information indicating the “second control state” as described above may be associated with the state of the seat 86 and the deviation index in the control state adjustment information 156.

As described above, on the basis of the state of the seat 86 and the posture of the occupant, the automated driving controller 100 controls the subject vehicle M so that the behavior change of the subject vehicle M is less likely to occur or a margin degree of avoidance of the subject vehicle M for an obstacle (for example, a vehicle or an object) present around the subject vehicle M is increased, in comparison with the first control state. Therefore, it is possible to appropriately control the control state of the subject vehicle M in accordance with the state of the occupant.

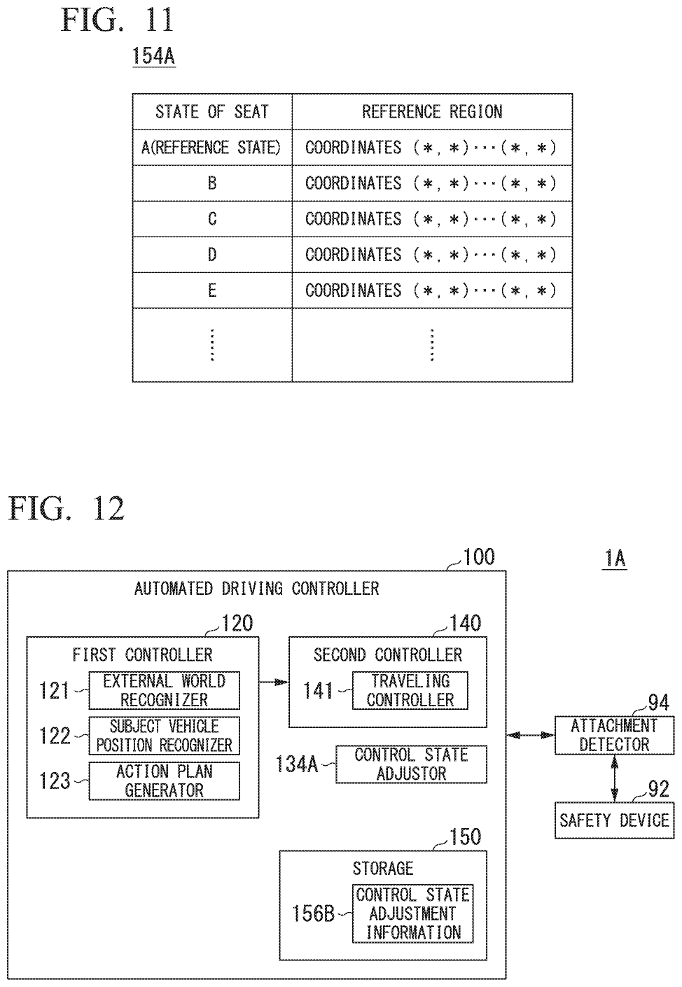

In addition, in the example described above, the reference region AR is set to a case in which the seat 86 is in the reference state, but the reference region AR may be set for each state of the seat 86 in the basic posture information 154. In this case, the occupant posture recognizer 132 refers to the basic posture information 154, to derive the deviation index indicating the degree of the region of the body of the occupant deviating from the reference region AR, on the basis of the image captured by the vehicle interior camera 90. FIG. 11 is a diagram showing an example of the basic posture information 154A including the reference region AR set for each state of the seat 86.

In the first embodiment described above, on the basis of the recognition result of the occupant posture recognizer 132, in a case in which it is determined that the occupant is in the first state that is the non-steady state different from the steady state, the automated driving controller 100 controls the control state of the subject vehicle M so that the behavior change of the subject vehicle M is less likely to occur or the margin degree of the avoidance of the subject vehicle M for the obstacle present around the subject vehicle M is increased, in comparison with the first control state in a case in which it is determined that the state is not the first state. Therefore, it is possible to appropriately control the control state of the subject vehicle M in accordance with the state of the occupant.

### Second Embodiment

Hereinafter, the second embodiment will be described. In the first embodiment, in a case of the first state in which the occupant is in the first state where the occupant is in the non-steady posture different from the steady posture, the automated driving controller 100 changes the control state of the subject vehicle M from the first control to the second control state. On the other hand, in the second embodiment, in the second state in which a predetermined safety device is not attached to the body of the occupant, the automated driving controller 100 changes the control state of the subject vehicle M from the first control to the second control state. Here, differences from the first embodiment will be mainly described, and descriptions of functions and the like common to the first embodiment will be omitted.

FIG. 12 is a diagram showing a functional constitution of a vehicle system 1A of the second embodiment. In FIG. 12, the functional constitution other than the automated driving controller 100 shown in the first embodiment is omitted. The vehicle system 1A further includes a safety device 92 and an attachment detector 94 in addition to the functional constitution of the vehicle system 1 of the first embodiment. In addition, the vehicle system 1A includes a control state adjustor 134A and control state adjustment information 156B, instead of the control state adjustor 134 and the control state adjustment information 156, respectively. Note that, in the vehicle system 1A of the second embodiment, the seat state detection sensor 88, the seat state recognizer 130 of the automated driving controller 100, the occupant posture recognizer 132, the seat state information 152, and the basic posture information 154 may be omitted.

The safety device 92 is, for example, a seat belt. The attachment detector 94 detects whether or not a tongue is inserted into a buckle of the seat belt, and outputs a detection result to the automated driving controller 100.

The control state adjustor 134A controls the control state of the subject vehicle M so that the behavior change of the subject vehicle M is less likely to occur or the margin degree of the avoidance of the subject vehicle M for the obstacle present around the subject vehicle M is increased in comparison with the first control state, in a case in which the occupant does not wear the safety device 92, in comparison with a case in which the occupant wears the safety device 92, with reference to the control state adjustment information 156B.

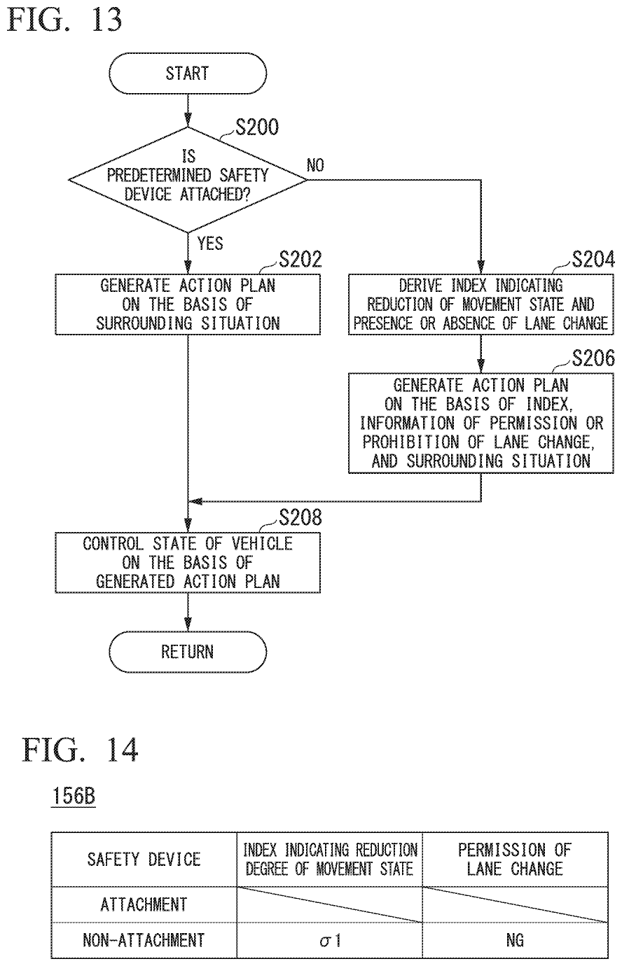

FIG. 13 is a flowchart showing a flow of a process executed by the automated driving controller 100 of the second embodiment. First, the control state adjustor 134A determines whether or not the safety device 92 is attached to the occupant on the basis of the detection result of the attachment detector 94 (step S200). In a case in which the safety device 92 is attached to the occupant, the action plan generator 123 generates an action plan on the basis of the surrounding situation of the subject vehicle M recognized by the external world recognizer 121 (step S202).

In a case in which the safety device 92 is not attached to the occupant, the control state adjustor 134A refers to the control state adjustment information 156B to derive the index indicating the reduction of the movement state, and the information indicating the permission of the lane change or the prohibition of the lane change (step S204). FIG. 14 is a diagram showing an example of a content of the control state adjustment information 156B. The control state adjustment information 156B is information in which the index indicating the reduction degree of the movement state and the information indicating the permission of the lane change or the prohibition of the lane change are associated with the presence or absence of the attachment of the safety device 92.

Next, the action plan generator 123 generates the action plan on the basis of the index derived by the control state adjustor 134A, the information indicating the permission of the lane change or the prohibition of the lane change, and the surrounding situation of the subject vehicle M recognized by the external world recognizer 121 (step S206). In addition, the automated driving controller 100 controls the subject vehicle M on the basis of the action plan generated by the action plan generator 123 (step S208). Therefore, a process of one routine of the present flowchart is ended.

By the process described above, the automated driving controller 100 is able to appropriately control the control state of the subject vehicle M in accordance with the state of the occupant by adjusting the control state of the subject vehicle M on the basis of the attachment state of the safety device 92.

According to the second embodiment described above, on the basis of the detection result of the attachment detector 94 that detects the state of the occupant in the vehicle, in a case in which it is determined that the state is the second state in which the predetermined safety device 92 is not attached to the body of the occupant, the automated driving controller 100 controls the control state of the subject vehicle M so that the behavior change of the subject vehicle M is less likely to occur or the margin degree of the avoidance of the subject vehicle M for the obstacle present around the subject vehicle M is increased in comparison with the first control state in a case in which it is determined that the state is not the second state. Therefore, it is possible to appropriately control the control state of the subject vehicle M in accordance with the state of the occupant. In addition, in a case in which the occupant does not want the subject vehicle M to be controlled to the second control state, the occupant is able to avoid the subject vehicle M from being controlled to the second control state by wearing the safety device 92.

### Third Embodiment

Hereinafter, the third embodiment will be described. In the second embodiment, the safety device 92 has been described as the seat belt. On the other hand, in the third embodiment, the safety device 92 is described as an air bag jacket. Here, differences from the second embodiment will be mainly described, and descriptions of functions and the like common to the first embodiment will be omitted.

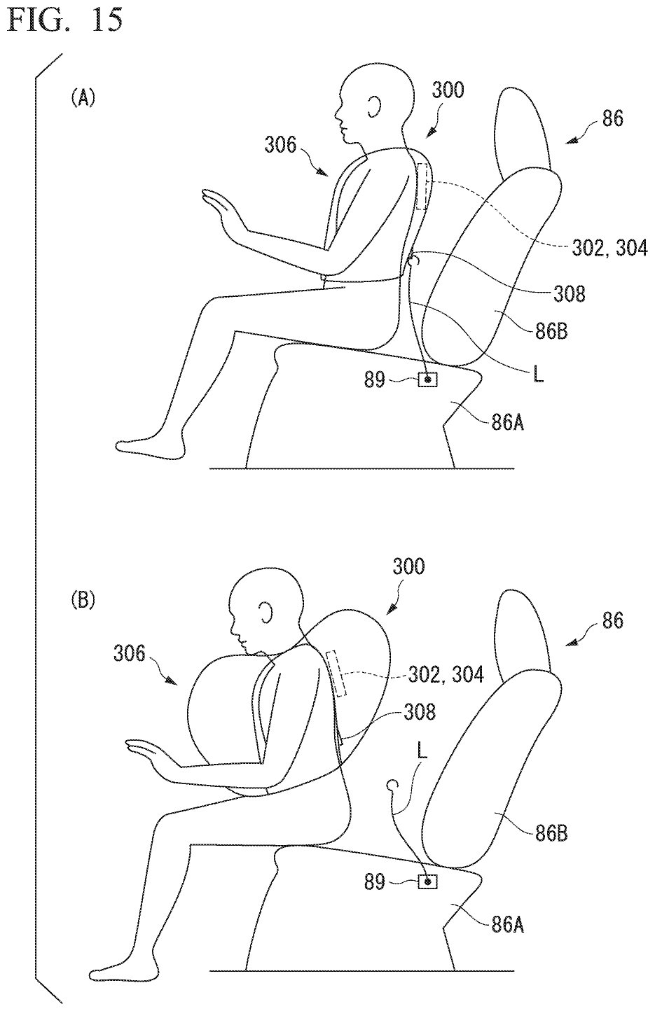

FIG. 15 is a diagram showing an appearance of the air bag jacket 300. In the air bag jacket (jacket air bag) 300, an inflator 302, an ignition circuit 304, and an air bag 306 deployed with gas output from the inflator are attached to a jacket body. The jacket air bag 300 deploys the air bag 306 in a case in which a predetermined acceleration occurs in an occupant wearing the jacket air bag. For example, the jacket air bag 300 has a predetermined connection mechanism 308, and the connection mechanism 308 is connected to a traction line L provided in the vehicle. The vehicle is provided with a winding device 89 that controls a degree of slack of the traction line L. For example, the occupant pulls out the traction line L wound by the winding device 89 and connects the traction line L to the connection mechanism 308. In a case in which the traction line L is pulled with a pulling force less than a predetermined force, the winding device 89 controls the traction line L to have a predetermined tension in accordance with the pulling force. In a case in which the traction line L is pulled with a predetermined acceleration or more, the winding device 89 locks the traction line L. That is, in a case in which the acceleration equal to or greater than a predetermined level occurs in the occupant wearing jacket air bag 300 in a state in which the traction line L is connected to the connection mechanism 308, the traction line L is locked. Therefore, the occupant moves away from the traction line L, and thus the connection mechanism 308 is separated from the vehicle. In addition, by electrically detecting the separation, the inflator is ignited and the air bag is deployed. (A) of FIG. 15 shows the jacket air bag 300 before the air bag is deployed, and (B) of FIG. 15 shows the jacket air bag 300 after the air bag is deployed.

Note that, when the occupant connects the traction line L to the connection mechanism 308, in a case in which the traction line L wound by the winding device 89 is pulled out, the attachment detector 94 detects that the traction line L is connected to the jacket air bag. In addition, the attachment of the safety device 92 may be detected on the basis of the information input by the occupant to the HMI 30, or may be detected by analyzing the image of the vehicle interior camera 90.

The control state adjustor 134A determines whether or not the safety device 92 is attached to the occupant on the basis of the detection result of the attachment detector 94. In a case in which the safety device 92 is not attached to the occupant, the control state adjustor 134A refers to the control state adjustment information 156B to derive the index indicating the reduction of the movement state, and the information indicating the permission of the lane change or prohibition of the lane change. The action plan generator 123 generates the action plan on the basis of the index derived by the control state adjustor 134A and the surrounding situation of the subject vehicle M recognized by the external world recognizer 121.

Note that, in the control state adjustment information 156B, attachment of a plurality of safety devices 92 may be considered. For example, the index or the like indicating the reduction degree of the movement state may be associated with the presence or absence of the attachment of each of the seat belt and the jacket air bag 300. The index indicating the reduction degree of the movement state tends to be low in a case in which the safety device 92 is attached (or as the number of the attached safety devices 92 increases). In addition, the index indicating the reduction degree of the movement state tends to be lower in a case in which the seat belt is attached and the jacket air bag 300 is not attached than a case in which the seat belt is not attached and the jacket air bag 300 is attached.

The jacket air bag 300 has been described that the connection mechanism 308 is connected to the traction line L provided in the vehicle, but is not limited thereto. For example, the jacket air bag 300 may include an acceleration sensor. In this case, the jacket air bag 300 includes a controller that deploys the air bag of the jacket air bag 300 in a case in which the acceleration sensor detects an acceleration equal to or greater than a predetermined level.

According to the third embodiment described above, on the basis of the detection result of the attachment detector 94 that detects the state of the occupant in the vehicle, in a case in which it is determined that the state is the second state in which the jacket air bag 300 is not attached to the body of the occupant, the automated driving controller 100 controls the control state of the subject vehicle M so that the behavior change of the subject vehicle M is less likely to occur or the margin degree of the avoidance of the subject vehicle M for the obstacle present around the subject vehicle M is increased in comparison with the control state in a case in which the jacket air bag 300 is attached to the body of the occupant. Therefore, it is possible to appropriately control the control state of the subject vehicle M in accordance with the state of the occupant.

Note that, on the basis of the recognition result of the external world recognizer 121 in addition to the state of the occupant, in a case in which it is determined that a congestion degree is high, the automated driving controller 100 may perform control so that the behavior change of the subject vehicle M is less likely to occur or the margin degree of the avoidance of the subject vehicle M for the obstacle present around the subject vehicle M is increased in comparison with a case in which the congestion degree is low. A fact that the congestion degree is high, for example, a case in which the number of vehicles around the subject vehicle M is equal to or greater than a predetermined number or a case in which an obstacle is present around the subject vehicle M. In a case in which it is determined that the congestion degree is high, the automated driving controller 100 may decelerate the subject vehicle M and stop the subject vehicle M.

In addition, in addition to the state of the occupant, in a case in which the occupant is performing a predetermined operation, the automated driving controller 100 may perform the control so that the behavior change of the subject vehicle M is less likely to occur or the margin degree of the avoidance of the subject vehicle M for the obstacle present around the subject vehicle M is increased in comparison with a case in which the occupant is not performing the predetermined operation. The predetermined operation is, for example, a state in which the occupant is playing a game, a state in which the occupant is reading a book, or the like. For example, in a case in which the occupant posture recognizer 132 analyzes the image captured by the vehicle interior camera 82 and determines that the occupant holds a controller of a game or a book by hand, the occupant posture recognizer 132 determines that the occupant is performing the predetermined operation.

In addition, in a case in which the occupant is in the first state or the occupant is in the second state and the occupant is standing up, the automated driving controller 100 may perform the control so that the behavior change of the subject vehicle M is less likely to occur or the margin degree of the avoidance of the subject vehicle M for the obstacle present around the subject vehicle M is increased in comparison with a case in which the occupant is in the first state or the second state and the occupant is not standing up. In addition, the automated driving controller 100 continues decelerating the vehicle while the occupant is in the first state or the occupant is in the second state and the occupant is standing up. Note that the determination as to whether or not the occupant is standing up is made by analyzing the image captured by the vehicle interior camera 82 by the occupant posture recognizer 132.

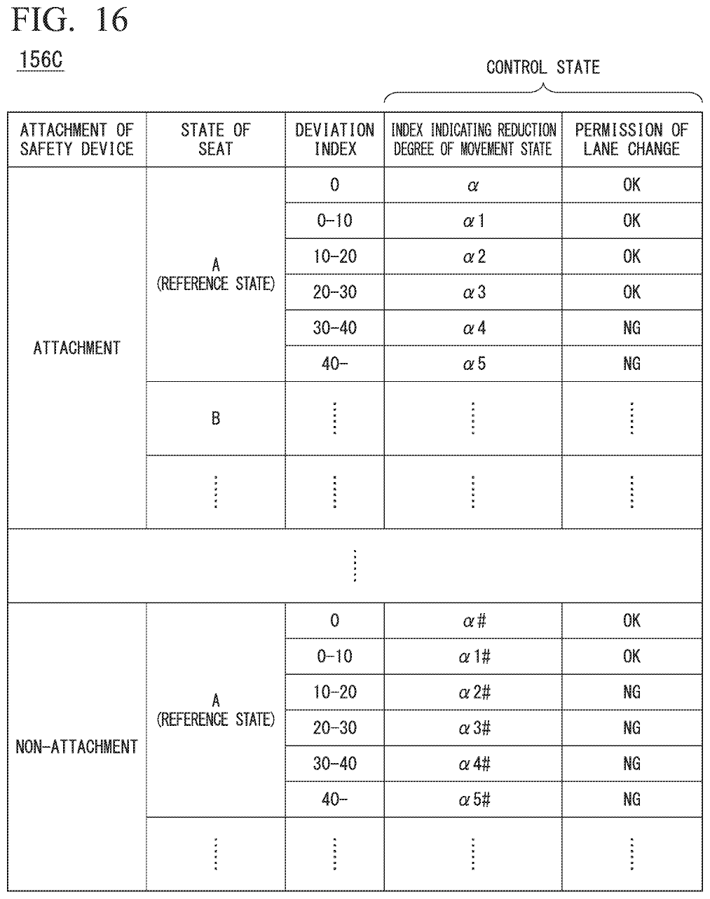

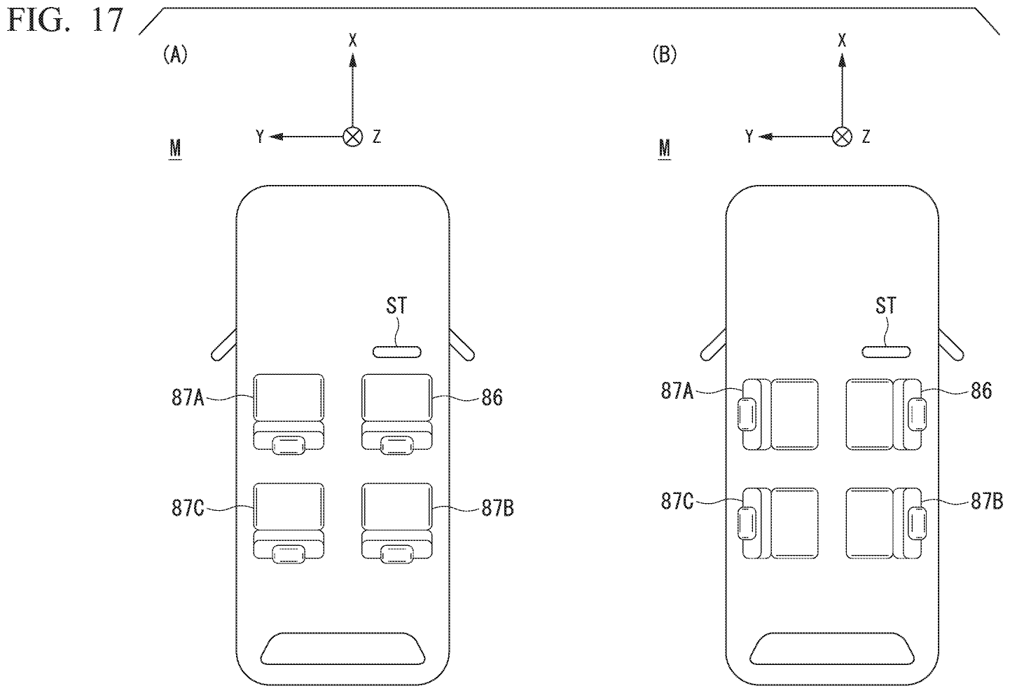

In addition, the processes of the first to third embodiments may be integrated. In this case, the control state adjustor 134 refers to control state adjustment information 156C to derive the index indicating the reduction degree of the movement state. FIG. 16 is a diagram showing an example of a content of the control state adjustment information 156C. The control state adjustment information 156C is information in which the presence or absence of the safety device 92, the state of the seat 86, the deviation index, the index indicating the reduction degree of the movement state, and information of the permission of the lane change or the prohibition of the lane change are associated with each other. For example, in a case in which the safety device 92 is not attached, or as the deviation index is larger, the index indicating the reduction degree of the movement state is larger.

In addition, in the first embodiment and the second embodiment, attention is paid to the state of the seat 86 on which the driver is seated, the posture of the driver, and the like, but the present invention is not limited thereto. For example, on the basis of a state of a passenger seat, a state of a rear seat, a posture of an occupant seated on the seat described above, and the like, the index indicating the reduction degree of the movement state, and the information indicating the permission of the lane change, the branching, and the merging or the prohibition of the lane change, the branching, and the merging may be derived. In this case, the control state adjustor 134 derives the index on the basis of the state of the seat of each seat and the posture of the occupant, statistically processes the derived index, and derives an index to be reflected in the action plan.

In addition, in each of the above-described embodiments, it is described that the control state is controlled to the second control state, focusing on the state of the seat 86. However, the control state may be controlled to the second control state on the basis of a disposition of the seat. FIG. 17 is a diagram showing the disposition of the seats. For example, as shown in (A) of FIG. 17, a disposition in which seats 86, 87A, 87B, and 87C in the vehicle interior are directed in the progress direction (X direction) is a reference disposition. Note that the seat 87A is a passenger seat, the seat 87B is a rear seat disposed behind the driver's seat, and the seat 87C is a rear seat disposed behind the passenger seat. On the other hand, as shown in (B) of FIG. 17, in a case in which the seats are disposed differently from the reference disposition, in which the seats are directed in the Y direction orthogonal to the progress direction, control may be performed so that the behavior change of the subject vehicle M is less likely to occur or the margin degree of the avoidance of the subject vehicle M for the obstacle present around the subject vehicle M is increased in comparison with a control state in the reference disposition.

In this case, the control state adjustment information 156 is associated with information indicating the control state for each seat disposition. In a case in which the seat is not the reference disposition, the control state adjustment information 156 may be associated with information that indicates performing the control so that the behavior change of the subject vehicle M is less likely to occur or the margin degree of the avoidance of the subject vehicle M for the obstacle present around the subject vehicle M is increased in comparison with a case in which the seat is the reference disposition. In addition, in a case in which the seat is not the reference disposition and the safety device 92 is not attached (in a case in which the state is not the first state or the second state), the control state adjustment information 156 may be associated with the information that indicates performing the control so that the behavior change of the subject vehicle M is less likely to occur or the margin degree of the avoidance of the subject vehicle M for the obstacle present around the subject vehicle M is increased in comparison with a case in which the seat is the reference disposition and the safety device 92 is not attached. For example, in a case in which the seat in the vehicle interior is directed to the progress direction and the safety device 92 is not attached as shown in (A) of FIG. 17, the control state adjustment information 156 may be associated with the information indicating reducing the vehicle speed, and in a case in which the seat in the vehicle interior is directed to the direction orthogonal to the progress direction and the safety device 92 is not attached as shown in (B) of FIG. 17, the control state adjustment information 156 may be associated with the information indicating stopping the subject vehicle M.

In addition, a reference region may be set for each combination of the disposition of the seat and the state of the seat. In this case, the occupant posture recognizer 132 derives the deviation index of the occupant of the vehicle with respect to the reference region that is set for the disposition of the seat, the state of the seat, and each combination of the disposition of the seat and the state of the seat. In addition, the control state adjustment information 156 is associated with the disposition of the seat, the state of the seat, the deviation index, the index indicating the reduction degree of the movement state, and the information indicating the permission of the lane change or the prohibition of the lane change. The control state adjustor 134 refers to the control state adjustment information 156 described above to derive the index indicating the reduction degree of the movement state. At this time, the presence or absence of the attachment of the safety device 92 may be additionally taken into consideration.

According to the embodiment described above, the state detector (10 and 94) configured to detect the state of the occupant in the vehicle, and the automated driving controller 100 configured to execute the automated driving that automatically controls at least one of the acceleration/deceleration or the steering of the vehicle are provided. In a case of the first state in which the posture of the occupant is the non-steady posture different from the steady posture or in a case of the second state in which the predetermined safety device 92 is not attached to the body of the occupant, the automated driving controller 100 changes the control state of the subject vehicle M from the first control state to the second control state in a case in which the occupant is not in the first state or the second state, on the basis of the detection result of the state detector.

Although aspects for carrying out the present invention have been described above using the embodiments, the present invention is not limited to these embodiments at all, and various modifications and substitutions may be added without departing from the gist of the present invention.

### REFERENCE SIGNS LIST

1 Vehicle system
82 Vehicle interior camera
88 Seat state detection sensor
92 Safety device
94 Attachment detector
100 Automatic driving controller
123 Action plan generator
130 Seat state recognizer
132 Occupant posture recognizer
134 Control state adjustor
152 Seat state information
154 Basic posture information
156 Control state adjustment information
M Subject vehicle

1. A vehicle control system comprising:
a state detector configured to detect a state of an occupant in a vehicle; and
an automated driving controller configured to execute automated driving that automatically controls at least one of acceleration/deceleration or steering of the vehicle,
wherein, in a case of a first state in which a posture of the occupant is a non-steady posture different from a steady posture or in a case of a second state in which a predetermined safety device is not attached to a body of the occupant, the automated driving controller is configured to change a control state of the vehicle from a first control state to a second control state in a case in which the occupant is not in the first state or the second state, on the basis of a detection result of the state detector.

2. The vehicle control system according to claim 1, wherein the second control state is a control state in which a behavior change of the vehicle is less likely to occur or a control state in which a margin degree of avoidance of the vehicle for an obstacle present around the vehicle is increased, in comparison with the first control state.

3. The vehicle control system according to claim 2, wherein the automated driving controller is configured to perform adjustment of a degree to which the behavior change of the vehicle is less likely to occur or a degree to which the margin degree of the avoidance of the vehicle for the obstacle present around the vehicle is increased, on the basis of the degree to which the posture of the occupant deviates from the steady posture.

4. The vehicle control system according to claim 1, wherein the first state is a state in which a proportion of a portion of the body of the occupant present outside a range of a reference region that is set in advance is equal to or greater than a predetermined level.

5. The vehicle control system according to claim 4, wherein the automated driving controller is configured to perform control so that the behavior change of the vehicle is less likely to occur or the margin degree of the avoidance of the vehicle for the obstacle present around the vehicle is increased in the second control state, as the number of predetermined parts of the body of the occupant present outside the range of the reference region that is set in advance is increased, or as a region of the body of the occupant present outside the range of the reference region that is set in advance is increased.

6. The vehicle control system according to claim 1, wherein the second control state is a control state for reducing a vehicle speed of the vehicle.

7. The vehicle control system according to claim 1, wherein the second control state in a state in which the vehicle follows a preceding vehicle is a control state in which a vehicle to be followed is changed to a vehicle having a slower speed than the vehicle to be followed.

8. The vehicle control system according to claim 1, wherein the second control state is a control state in which an inter-vehicle distance with the preceding vehicle is increased.

9. The vehicle control system according to claim 1, wherein the second control state is a control state in which a lane change of the vehicle is prohibited.

10. The vehicle control system according to claim 1, further comprising:
a surrounding situation detector configured to detect a surrounding situation of the vehicle,
wherein the automated driving controller is configured to decelerate the vehicle as the second control state and stop the vehicle in a case in which it is determined that a congestion degree around the vehicle is high on the basis of a detection result of the surrounding situation detector.

11. The vehicle control system according to claim 10, wherein a fact that the congestion degree is high is a fact that it is detected that the number of surrounding vehicles is greater than or equal to a predetermined number by the surrounding situation detector.

12. The vehicle control system according to claim 1, wherein, in a case in which the occupant is in the first state or the second state and the occupant is performing a predetermined operation, the automated driving controller is configured to perform the control so that the behavior change of the vehicle is less likely to occur or the margin degree of the avoidance of the vehicle for the obstacle present around the vehicle is increased in the second control state, in comparison with a case in which the occupant is in the first state or the second state and the occupant is not performing the predetermined operation.

13. The vehicle control system according to claim 1, wherein, in a case in which the occupant is in the first state or the occupant is in the second state and the occupant stands up, the automated driving controller is configured to perform the control so that the behavior change of the vehicle is less likely to occur or the margin degree of the avoidance of the vehicle for the obstacle present around the vehicle is increased in the second control state, in comparison with a case in which the occupant is in the first state or the occupant is in the second state and the occupant does not stand up.

14. The vehicle control system according to claim 13, wherein, in a case in which the occupant is in the first state or the second state and the occupant stands up, the automated driving controller is configured to decelerate the vehicle as the second control state while the state continues.

15. The vehicle control system according to claim 1, wherein, in a case in which a disposition of a seat in the vehicle is different from a reference disposition that is set in advance and the occupant is in the first state or the occupant is in the second state, the automated driving controller is configured to perform the control so that the behavior change of the vehicle is less likely to occur or the margin degree of the avoidance of the vehicle for the obstacle present around the vehicle is increased in the second control state, in comparison with a case in which the disposition of the seat in the vehicle is the reference disposition that is set in advance and the occupant is in the first state or the occupant is in the second state.

16. A vehicle control method causing an in-vehicle computer to:
detect a state of an occupant in a vehicle;
execute automated driving that automatically controls at least one of acceleration/deceleration or steering of the vehicle; and
change a control state of the vehicle from a first control state to a second control state in a case in which the occupant is not in the first state or the second state, in a case of a first state in which a posture of the occupant is a non-steady posture different from a steady posture or in a case of a second state in which a predetermined safety device is not attached to a body of the occupant, on the basis of a result of the detection result.

17. A non-transitory computer-readable storage medium that stores a computer program to be executed by a computer to perform at least:
detect a state of an occupant in a vehicle;
execute automated driving that automatically controls at least one of acceleration/deceleration or steering of the vehicle; and
change a control state of the vehicle from a first control state to a second control state in a case in which the occupant is not in the first state or the second state, in a case of a first state in which a posture of the occupant is a non-steady posture different from a steady posture or in a case of a second state in which a predetermined safety device is not attached to a body of the occupant, on the basis of a result of the detection result.
